(19) United States
(12) Patent Application Publication
(10) Pub. No.: US 2005/0210040 A1
(43) Pub. Date: Sep. 22, 2005

(54) Document organization and formatting for display

(75) Inventors: Timothy E. Beres, Boulder, CO (US); Curt Daniel Szymanski, Waunakee, WI (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Zenodata Corporation, Louisville, CO (US)

(21) Appl. No.: 10/804,467

(22) Filed: Mar. 18, 2004

(51) Int. Cl. G06F 17/00; G06F 17/30; G06F 9/44

(52) U.S. Cl. 707/100; 707/10; 707/206; 717/162

(57) ABSTRACT

Methods and systems are organizing and displaying documents for a title examination. In one embodiment, the method comprises receiving a plurality of records, each record having a plurality of attributes associated with a document recorded with a government entity. A plurality of organizational links are created, each link defining a relationship from a first document associated with one of the records to a second document associated with a second one of the records. The records and the created links are displayed.

### CROSS-REFERENCES TO RELATED APPLICATIONS

This application is related to the following co-pending, commonly-assigned and concurrently filed U.S. Patent Applications, the entirety of each of which are herein incorporated by reference for all purposes: Provisional U.S. patent application Ser. No. ______, entitled “PROPERTY RECORDS DATABASES AND SYSTEMS AND METHODS FOR BUILDING AND MAINTAINING THEM” (Attorney Docket No. 040143-000100); U.S. patent application Ser. No. ______, entitled “AUTOMATED RECORD SEARCHING AND OUTPUT GENERATION RELATED THERETO” (Attorney Docket No. 040143-000200); U.S. patent application Ser. No. ______, entitled “DOCUMENT SEARCH METHODS AND SYSTEMS” (Attorney Docket No. 040143-000300); Provisional U.S. patent application Ser. No. ______, entitled “CONFIDENCE-BASED NATURAL LANGUAGE PARSING” (Attorney Docket No. 040143-000500); and Provisional U.S. patent application Ser. No. ______, entitled “CONTEXTUAL CONVERSION OF LANGUAGE TO DATA” (Attorney Docket No. 040143-000600).

### BACKGROUND OF THE INVENTION

Title searches are typically performed on documents recorded with a government entity before a sale or refinance of a property. Title searches may be used for a variety of purposes. As one example, a title searches may be used by a title insurer to determine whether to issue a title insurance policy, the exclusions to apply to the policy, and/or the premium to be paid for the policy. Title searches may also be used by other parties, such as mortgage lenders and realtors, and for other purposes. A title search retrieves documents that may be relevant to the property under examination. These documents may include mortgages, prior conveyances, recorded liens, release of liens, release of mortgages, and other types of documents recorded with a government entity.

Historically, title searches have been performed by a physical visit to the records department of the government entity in which the property is situated. Even when the information is available in electronic format, the data obtained from the government entities will likely contain a number of inaccuracies (typographical errors in names, addresses, locations, etc.) and missing information. Because of these inaccuracies, standard search techniques may not retrieve all of the documents needed to perform an accurate title examination. Assuming the documents could be retrieved, a mechanism is needed to organize and display the retrieved documents.

### BRIEF SUMMARY OF THE INVENTION

Methods and systems are disclosed for organizing and displaying documents for a title examination. In one embodiment, the method comprises receiving a plurality of records. Each record has a plurality of attributes associated with a document recorded with a government entity. A plurality of organization links are created which defines a relationship from a first document associated with one of the records to a second document associated with a second one of the records. The records and the created links are displayed.

The organizational links may be created for a variety of relationships. For instance, an organizational link may be created for a document assigned to a second document. As another example, an organizational link may be created for a document that cures, probably cures, or partially cures a second document (e.g., a document which releases a lien document). Other examples include organizational links between a deed document and a second deed document to define a title chain, between a document that amends a second document, between a document that is a re-recordation of a second document, and between a deed document and a document which places a mortgage on the deed.

In some embodiments, the method may further include creating a sentinel link from one of the records to an indicator of an organizational property associated with the record. By way of example, a sentinel link may be created from a record used as a starting point for a title search to a starting search indicator. As other examples, a sentinel link may be created for a record associated with a lien document to a non-cured indicator when the remaining records do not include a record for a document curing the lien; for a record which may cloud ownership of a property to a title cloud indicator; and for records for documents that do not include a location attribute, a sentinel link may be created from the record to a name indicator indicating the record is associated with a name and not a location.

A sentinel link may also be created for a record associated with a good stop document for a title search to a good stop indicator. A document may be determined to be a good stop document if the record is associated with a deed of documents and the received records includes a second record associated with a mortgage document linked to the deed. Alternately, a document may be a good stop document if it is a deed document with a subdivision developer or the government as the grantor. The earlier dated warranty deed may also be used as a good stop document when there is a record for a later dated warranty deed and no intervening deeds.

The records may be displayed in a variety of ways. In one embodiment, the records may be displayed as an ordered list ordered by a record date attribute of the records. The displayed attributes of the records may further include one or more of a reception number, a document type, a document category, a grantee name, and a grantor name. In another embodiment, the records may be displayed as nodes in a graph and the created links may be displayed as edges in the graph. In a third embodiment, the records may be displayed in a first level of a hierarchical display format (e.g., a hierarchical tree format) and the linked records may be displayed at a nested level lower than the first level.

In some embodiments, the records may be displayed in a color-coded format. The color may indicate an organizational category of the document associated with the record. Organizational categories may include one or more of non-cured documents, possibly cured documents, documents which may cloud title to a property, cured lien documents, cured documents releasing a non-returned lien document, and good-stop documents for a title search. An initial record may also be color coded to indicate the record was used as a starting point for a search.

In a second embodiment, the method may comprise receiving a plurality of records, each record having a plurality of attributes associated with a document recorded with a government entity. Curing links are created which each define a curing relationship between one of the records associated with a lien document and a second one of the records associated with a cure document that releases the lien. One or more sentinel links are also created. Each sentinel link associates one of the records to an indicator of an organizational property associated with the record. The records are color coded with a color indicating a category of the record. The color coded records and the created links are displayed. The displayed attributes of the records include a recordation date, a reception number, and a document category.

The methods may be embodied in a system comprising logic and a display mechanism communicatively coupled to the logic. The logic is used to perform the method.

### BRIEF DESCRIPTION OF THE DRAWINGS

Illustrative embodiments in accordance with the invention are illustrated in the drawings in which:

FIG. 1 is a flow diagram of an exemplary method for organizing and displaying documents for a title examination;

FIG. 2 is a flow diagram of an exemplary method for defining organizational links which may be used by the method of FIG. 1;

FIG. 3 is a flow diagram of an exemplary method for defining sentinel links which may be used by the method of FIG. 2;

FIG. 4 is a flow diagram of an exemplary method for creating links for good stop documents which may be used by the method of FIG. 3;

FIG. 5 illustrates a first exemplary display of records in a list format which may be used by the method of FIG. 1;

FIG. 6 illustrates a second exemplary display of records in a graph format which may be used by the method of FIG. 1;

FIG. 7 illustrates a third exemplary display of records in a hierarchical format which may be used by the method of FIG. 1;

FIG. 8 illustrates an exemplary formatting of records for display to indicate an organizational category of the record;

FIG. 9 illustrates an exemplary embodiment of a system that may be used to organize and display records for a title examination.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Although concrete embodiments will be described with reference to organizing and displaying records for a title examination, the methods and systems described herein may be used in other types of applications. By way of example, the methods and systems may be used to retrieve genealogy records. Other uses are also contemplated.

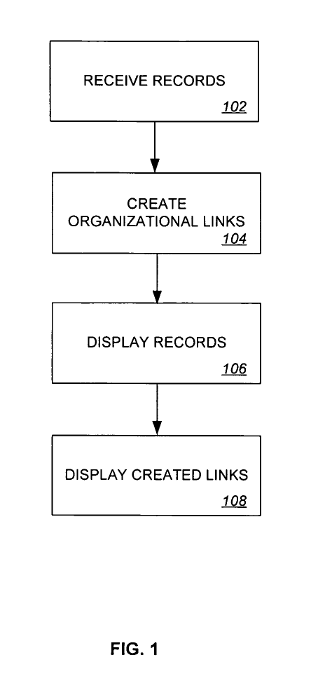

FIG. 1 illustrates an exemplary method for organizing and displaying documents for a title examination. A plurality of records is received 102. Each record has a plurality of attributes associated with a document recorded with a government entity. By way of example, the attributes may include a document date, a recordation date, a reception number or other type of government identifier, a document type, a document category, one or more names (such as grantor, grantee, etc.), and one or more location attributes indicating a location of a property associated with the document. In one embodiment, the records may be received from search logic which retrieves records associated with related documents which may be used for a title examination. The search logic may retrieve records from a data set as described in previously incorporated application Ser. No. ______ (Atty. Docket No. 040143-000300US).

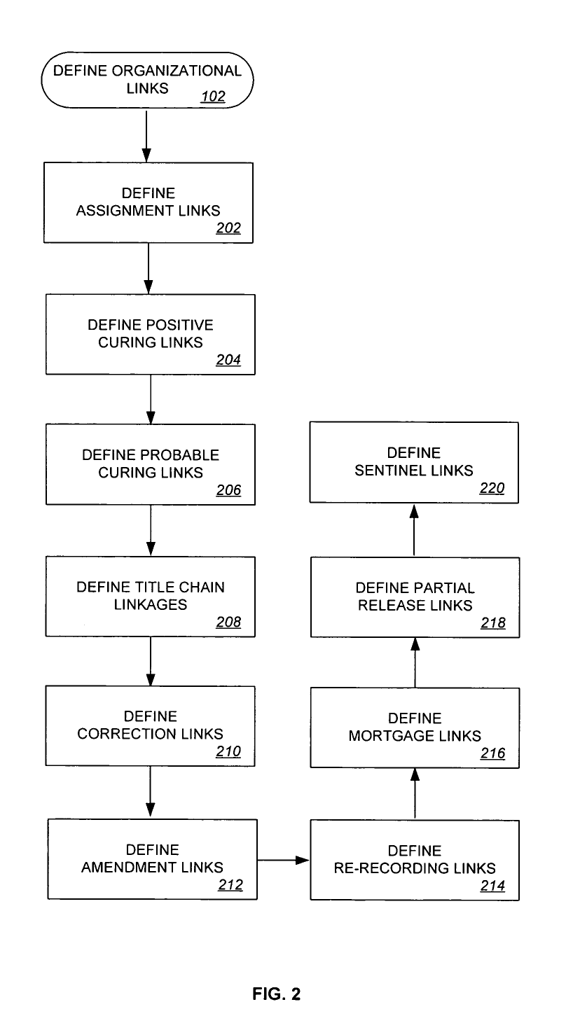

A plurality of organization links are created 102. Each organization link defines a relationship from a first document associated with one of the received records to a second document associated with a second one of the received records. The organizational links may be used to display a relationship between the documents that may facilitate a title examination. As will be described in further detail below with reference to FIG. 2, organizational links may be created for a variety of different relationship types.

The received records are displayed 106 to a user. Additionally, the created organizational links are also displayed 108. As will be described more fully below, the records may be displayed in a variety of ways that may facilitate title examination. In alternate embodiments, the records and the links may not be displayed, but instead the records and the organizational linkages may be archived, transmitted, or stored for use by subsequent computerized processes. Links may be stored in Extended Markup Language (XML) format, binary format, Hyper Text Markup Language (HTML) format, American Standard Code for Information Interchange (ACSII) format, or other type of format.

FIG. 2 illustrates a method that may be used to define 102 organizational links. Linkages may be created for a variety of relationships. A document may not have any organizational links or may have organizational links to one or more documents. Additionally, multiple organizational links of different types may exist between any two documents. A determination may be made that a relationship exists between two documents by applying business rules to the attributes of records associated with the recorded documents. Each rule may have the capability of adding, removing, or modifying organizational linkages. An evaluation may be made as to whether a document satisfies a business rule by using attributes such as record date, document date, reception number (or other type of government identifier), document type, document category which includes a plurality of document types, names associated with the document (e.g., grantor, grantee, third party, etc.), dollar amount associated with mortgage documents, document linkages noted on the document, document location data, and other applicable attributes.

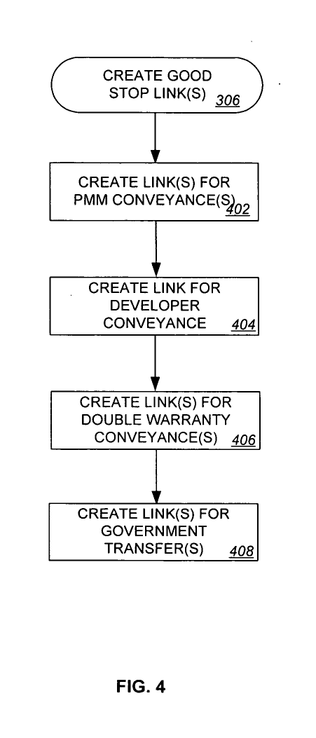

The business rules may vary depending upon the location of the property undergoing title examination. For instance, rules may be included or excluded depending upon the county or state in which the property is located. Additionally, in some embodiments, some of the business rules may be configured based on parameters provided by a user. As an illustration, a user may indicate which types of documents may be used as a good-stop. Good-stop documents will be explained more fully below with reference to FIG. 4.

Based on the application of the rules to the attributes of the records associated with the recorded documents, one or more assignment links may be defined 202. Each assignment link links a first record associated with a first document to a second record associated with a second document assigned to the first document. As an example, an assignment relationship may exist between a mortgage document and a subsequent assignment when the grantee on the mortgage matches or fuzzily matches the grantor on the assignment and a link exists between the assignment and the mortgage. Assignment documents may also be subsequently assigned.

One or more positive curing links may also be defined 204. For example, a positive curing relationship exists when a document cures or releases a mortgage or other type of lien document. A document may be determined to cure another document by examining, the document ordering information (e.g., the record date, the document date, and/or a sequenced reception number). The curing document must be dated the same day or later than the document to be cured. The document type may also be examined to determine if the document is a type that releases the document to be cured. For instance, the document type of a document curing a mortgage may be a release of mortgage. Additionally, the names associated with the curing document may be examined to determine if they match (exactly or fuzzily) the names associated with the document to be cured. A fuzzy match occurs when the names approximately match each other, but may have some differences that may have occurred because of a typographical error or other reason. The documents may also be examined to determine whether the cured document contains a reference to the document to be cured and whether judicial documents contain the same case number. Other rules may also be used to determine if a curing relationship exists.

A positive curing relationship may only be determined to exist when multiple curing rules are satisfied. If a positive curing relationship cannot be determined because not enough criteria are met or some other deficiency, two documents may be determined to have a probable curing relationship because one or more of the aforementioned criteria are met. Thus, organizational links may be defined 206 between documents having a probable curing relationship.

Title chain linkages may also be defined 208. Each title chain link defines a link between a deed document conveying the property to a later deed document. A title chain linkage may be determined to exist between two deed documents if the grantee on the first deed document is the grantor on the second deed document. Before creating a title chain link, an examination may also be made to determine there are no other intervening deed documents.

Links may also be defined 210 between any two documents when one of the documents corrects a second document. Amendment links may also be defined 212 between two documents when one of the documents amends the other document. Both of these relationships may be determined to exist if a record associated with one of the documents has an attribute indicating a reference to a second document with the reference having a type indicating the first document amends or corrects the second document.

A re-recording relationship may also be determined to exist in a similar fashion as that of amendment and corrective relationships. One of the documents in the relationship may have a reference to a second document with a reference having a type indicating the first document is a re-recording of the second document. Thus, one or more re-recording links may be defined 214 between documents having a re-recording relationship.

Mortgage links may also be defined 216 between two documents when a document is a mortgage document that attaches to a deed document. A different type of link may be created for a document which is presumptively the first mortgage associated with the deed document. Rules may be applied to determine whether a mortgage document attaches to a deed document. For instance, a rule may specify the grantee name of the deed document fuzzily match the grantor name of the mortgage document. Another rule may specify that there be no intervening deeds between the documents. The date of the mortgage document may also be examined to determine if it its associated date is the same or later than the deed date. A presumptive first mortgage may be the first mortgage dated on or after the deed date.

A partial release relationship may exist between two documents when one of the documents partially releases (cures) the second document. This relationship may be determined to exist by applying the rules previously described with defining curing links. Additionally, the amount of the release may be examined to determine that it is less than the amount associated with the lien or mortgage document. Partial release links may be defined 218 between documents having a partial release relationship.

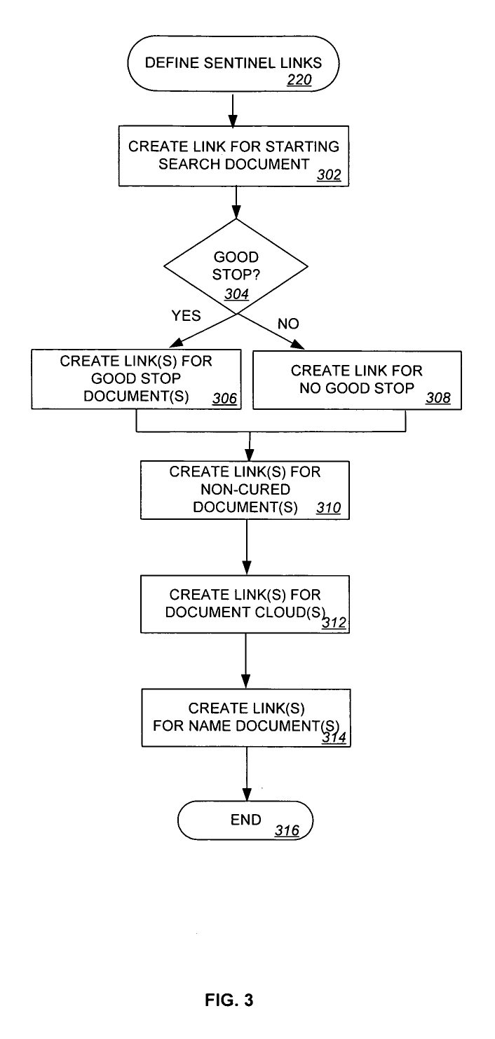

As will be described more fully below with reference to FIG. 3, sentinel links may also be defined 220 from one of the records to an indicator of an organizational property associated with the record. In some embodiments, the organizational links may be constrained to have two associated documents. In these embodiments, the sentinel link may be created by creating a link from a record to a simulated record associated with a simulated document. The simulated document indicates an organizational property of the linked record. Alternate mechanisms, such as flags, may also be used to define sentinel links.

It should be appreciated that in alternate embodiments, organizational links may be defined differently than illustrated in FIG. 2. In some embodiments, the manner in which the links are calculated may be defined or partially defined by a customer and/or product. Additionally, other types of organizational links may also be defined. For instance, links may be defined to plat maps or other type of plat documents in order to assist in identifying covenants and other restrictions on a property. Links for tenancy rights, title chaining which occurs from divorce or death, and other types of links which may facilitate title examination may also be defined. It should also be appreciated that in some embodiments, some of the organizational links described above may not be defined.

FIG. 3 illustrates an exemplary method that may be used to define 220 sentinel links. In some embodiments, as more fully described in previously incorporated application Ser. No. ______ (Atty. Docket No. 040143-000300US), the records may have been received from search logic using an initial one of the records as a starting point for the search. In these embodiments, a sentinel link may be created 302 from the initial record to a starting search indicator.

A determination 304 may be made as to whether any of the received records are associated with a good stop document for a title search. For those documents that are determined to be good stop documents, a sentinel link may be created 306 for each of the associated records to a good stop indicator. Otherwise if the records do not include a record associated with a document which is a good stop for the title search, the record associated with the deed having the earliest date may be selected. A sentinel link may be created 308 from the selected record to a no good stop indicator.

Additionally, a sentinel link may be defined for each record associated with a lien or mortgage document that has not been cured. Each lien/mortgage record may be examined to determine if a positive or probable curing link has been defined 204/206. For each document which has not been cured, a sentinel link may be created 310 from the record associated with the document to a non-cured indicator.

Sentinel links may also be created 312 for documents which may cloud title to a property. By way of example, a document may cloud title if a break in the title chain is detected. As another example, a Notice of Commencement less than a year old when a mortgage exists on the same property may also cloud title if a release of the Notice of Commencement isn't found. A sentinel link to a title cloud indicator is created 312 for each record associated with a document which may cloud title to a property.

Some of the records may be associated with documents that apply only to a name and not to a property. Records that do not include any attributes which indicate a location (e.g., address, parcel identification, block identification, etc.) may be determined to be records of this type. Sentinel links may be created 314 for these records linking them to a name indicator which indicates the record is associated with a name and not a location. The method then ends 316.

It should be appreciated that the sentinel links may be defined 220 in any order. Additionally, it should be appreciated that in alternate embodiments, different sentinel links may be defined. By way of example, a sentinel link may be defined for a record associated with a release document to a null release indicator when there is not a record in the record set to which the release is applied. Other examples are also contemplated. Additionally, all of the types of sentinel links described above may not be defined 220.

FIG. 4 illustrates an exemplary method that may be used to create 306 good stop link(s) for records associated with a good stop document. A good stop link may be created 402 for each purchase money mortgage (PMM) conveyance. A PMM conveyance is a conveyance (deed) from a first party to a different party and to which a mortgage relates. The grantor on the mortgage matches (fuzzily) the grantee on the deed and the mortgage has a dollar amount equal to or greater than 80% of the fair market, purchase price, or appraised value of the conveyed property. The conveyance may not be a PMM conveyance if it is not an Arms Length Transaction in which the grantor and the grantee are not related and the conveyance involved a pledge or transfer of collateral (usually money). Thus, quit claim deeds or deeds that lack a suitable value of collateral (e.g., a conveyance for $1) may not-be Arms Length Transactions as they do not satisfy the second test. Attributes of the deed and mortgage records may be examined to determine if the criteria for a PMM conveyance is fulfilled. If there was a PMM conveyance, good stop links may be created 402 to either or both of the PMM documents (i.e., deed and mortgage).

A good stop link may also be created 404 for a record associated with a deed from an original subdivision developer (e.g., having the subdivision developer as a grantor) to a different grantee. Good stop link(s) may also be created 406 for double warranty conveyances. A double warranty conveyance exists when there is a record associated with a first warranty deed document having a first date and a second record associated with a second warranty deed document having a second date later than the first date. The first document may be determined to be a good stop 406 if there are no intervening records associated with a conveyance, such as a quit claim deed, between the two warranty deeds.

Records associated with government transfers may also be assigned 408 a good stop link. A government transfer deed is a deed in which a government agency is the grantor. By way of example, the government agency may be Housing and Urban Development (HUD). As another example, a government transfer may be an original land grant from the government to the grantee. Government transfer deeds are good stop documents for which a good stop link is created 408.

It should be appreciated that different or additional categories may be used to create good stop links. For example, a good stop link may be created to a quiet title document conveyance as it may be safely assumed the grantee of the property is the lawful owner. Other examples are also contemplated. It should also be appreciated that alternate embodiments may not include all of the good stop categories described above.

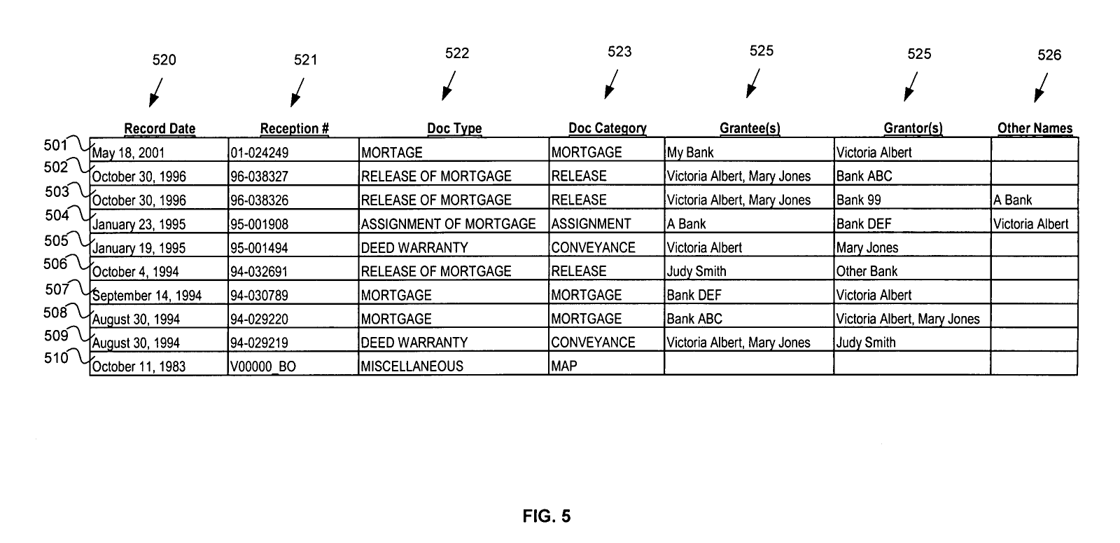

FIG. 5 illustrates an example of how the records may be displayed 108. Each record is displayed as a row in a table with different attributes being displayed in different columns. Each of the displayed attributes for the record includes a record date indicating the date 520 the document associated with the record was recorded, a reception number 521 (government identifier) assigned to the document, and a document type 522. The document type may be an attribute of the record. As shown in FIG. 5, the document types may include mortgage, release of mortgage, assignment of mortgage, deed warranty, and miscellaneous. Other type of documents filed at the county, such as plat maps, liens, release of liens, UCC terminations, and other encumbrances, may also be used to classify document types.

The displayed attributes further include a document category 523. The document category may be a more general category that applies to a variety of document types. For instance, the document categories may include mortgage, release, assignment, conveyance, legal, lien, encumbrance, probate, judgment and map. Other categories may also be used. If applicable, the displayed attributes may also include one or more grantee names 525, one or more grantor names 525, and/or one or more other names 526 (e.g., third party names, etc.).

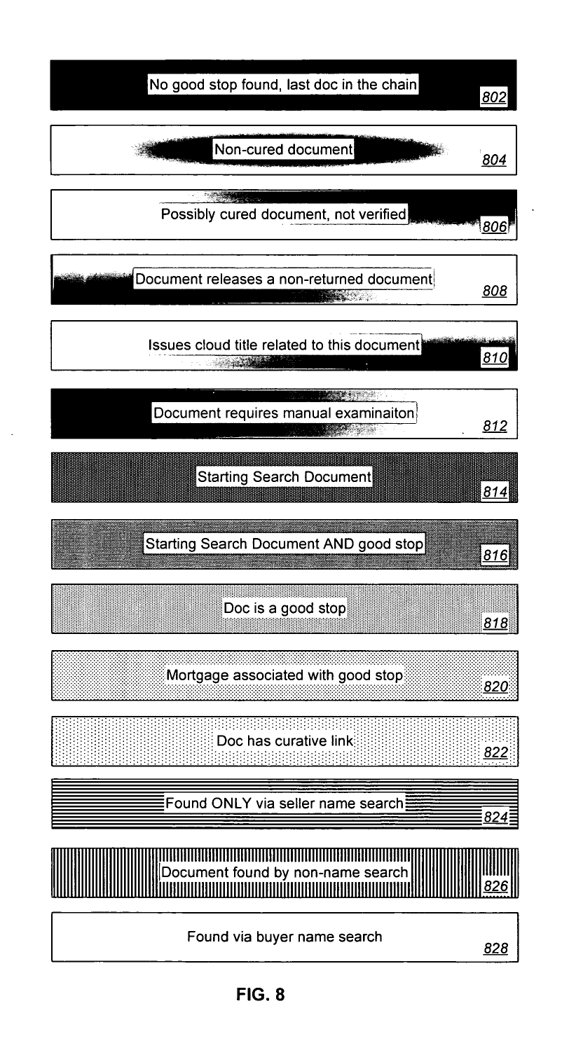

The records 501-510 may be displayed as ordered rows in the table which may be ordered by record date 520 or other attribute. As will be described with reference to FIG. 8, the displayed records may be color coded or formatted with some other type of indication to indicate organizational categories of the records. For example, records associated with sentinel links of a first category (e.g., non-cured documents) may be displayed in a color different than records associated with sentinel links of a second category (e.g., title cloud documents). As can be appreciated, the color coding may be used to illustrate sentinel links and some other types of organizational links. The color-coding may quickly convey to a title examiner which documents require closer examination. It should be appreciated that alternate embodiments may display attributes different from those illustrated in FIG. 5 (e.g., location attributes).

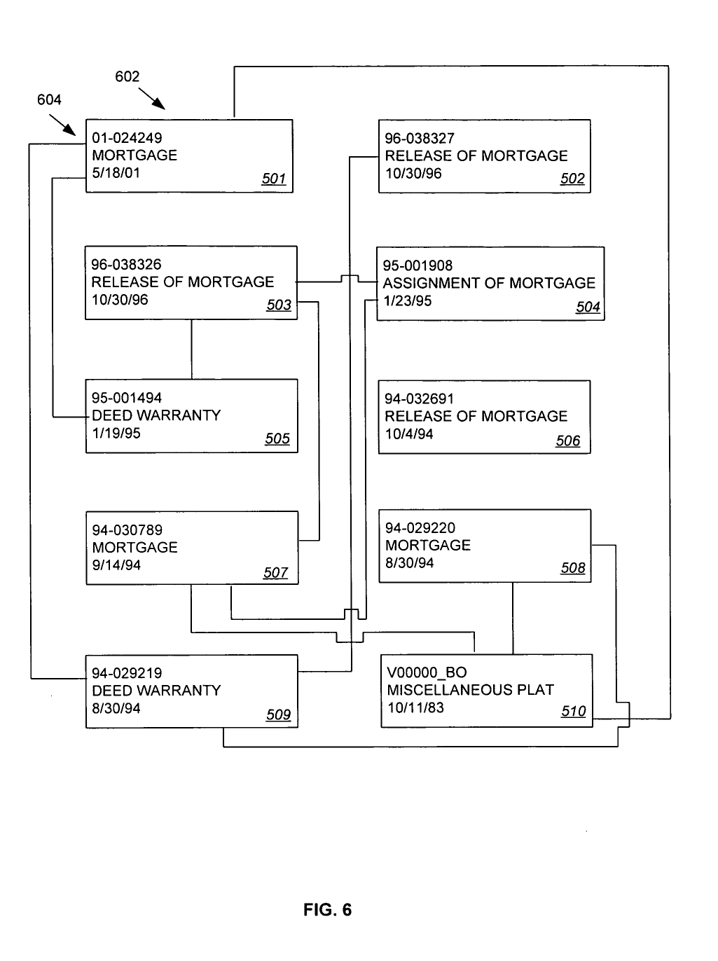

FIG. 6 illustrates a second exemplary embodiment of how the records may be displayed 106. Each of the records 501-510 may be displayed as a node in a graph. For instance, record 501 is displayed as node 602. Attributes that may be displayed in the nodes may vary by embodiment. By way of example, the displayed attributes for each record may include a reception number, a document type, and a recordation date. Other attributes may alternately or additionally be displayed in the nodes.

The organizational links and other link types may be displayed 108 as edges in the graph. As an example, a mortgage link is illustrated by the edge 604 between record 501 and record 509. In alternate embodiments, links of different types may be displayed differently. The edges may be displayed in different colors and/or different types of lines (e.g., dashed, dotted, solid, etc.) may be used to indicate a different linking relationship. For instance, edges can be dashed or colored to indicated different kinds of linkages and/or whether a link is a positive or possible link. As will be described more fully below, color coding may also be used to indicate an organizational property of the record (e.g., a record is associated with a sentinel link).

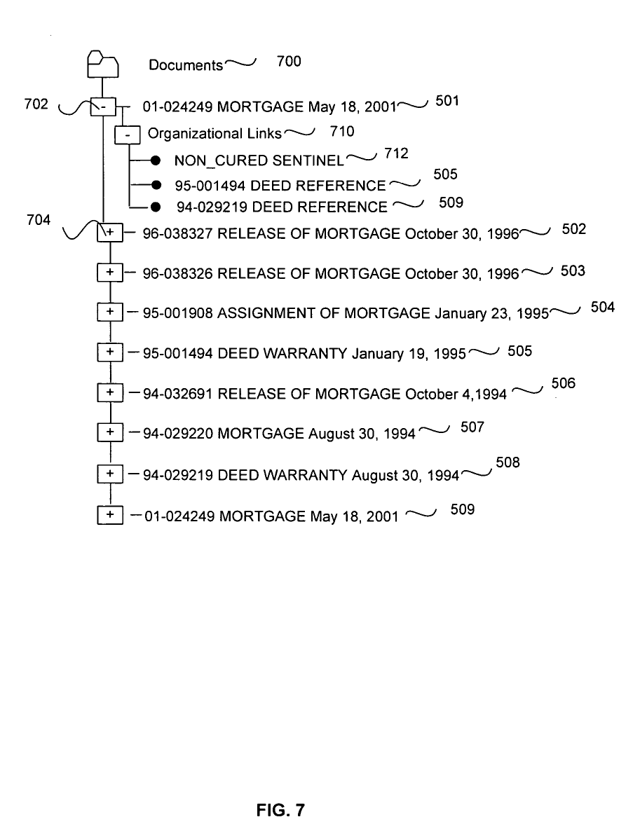

FIG. 7 illustrates a third exemplary embodiment of a manner in which records may be displayed 106. As shown in FIG. 7, the records are displayed in a hierarchical tree format. The first level of the tree lists the records 501-509 associated with the documents 700. Each record has a button next to it which may be used to expand or collapse the levels underneath the record. For instance 702 may be used to collapse the nested levels for record 501, while 704 may be used to expand the nested levels of record 502.

Each record has one or more nested levels underneath the record which may be used to display 108 the links between the records. Record 501 has been expanded to illustrate it has a second nested level for organizational links 710. Each record to which record 501 is linked is listed in the second nested level. A non-cured sentinel link 712 exists which indicates that the records 501-509 do not include a record associated with a document which releases the mortgage. Additionally, record 501 has organizational links to records 505 and 509. Hierarchical formats other than tree formats may also be used to display the records and the created links.

FIG. 8 illustrates an exemplary formatting of records for displaying an organizational category, such as a sentinel link, associated with the record. The formatting may be used with any of the display types described in FIGS. 5-7 or other display of the records. Each record displayed may be displayed using a different color or other type of formatting (e.g., font type, size, style) to indicate the organizational category. The formatting may quickly indicate to a title examiner or other user which documents require closer examination.

Records formatting with the 802 format may indicate that a good-stop document was not found and the formatted record is associated with the last document in the chain 802 (i.e., has a no good stop sentinel link 308). Records associated with non-cured documents may be displayed using format 804, which indicates these records have a non-cured sentinel linkage 310. Format 806 may be used to display records associated with documents that are possibly cured. These records may have a probable curing link 206 relationship with another record.

A record associated with a document which releases a document not associated with any of the received records may be displayed using format 808. Format 810 may be used to display records associated with documents that may cloud title to the property 316. A different format 812 may be used for records associated with other types of documents which may require manual examination.

The record associated with a document used as a starting point of a search for which the received records were returned may be indicated using format 814. This record may also have a starting search document sentinel link 302 associated with it. If the record is associated with a starting search document which is also a good stop, format 816 may alternately be used.

Format 818 may be used to indicate the record is associated with a deed document which is a good stop document, while format 820 may be used to indicate the record is associated with a mortgage document associated with the good stop. If a document, such as a lien or a mortgage, has a curative link 204, 206, the record associated with the document may be displayed using the 822 format.

If a record is associated with a document which was found only by a seller name search, format 824 may be used. Similarly, format 828 may be used to indicate records associated with documents which were found only be a buyer name search. These records may be associated with a name sentinel link 320. As described more fully in previously incorporated application Ser. No. (Atty. Docket No. 040143-000300US), the type of search which was used to return the document may be stored as part of the search. For records associated with documents which were found by a non-name search (e.g., a location search), format 826 may be used.

The format types 802-828 are exemplary in nature. Alternate embodiments may include a different combination of organizational categories and may include categories not illustrated in FIG. 8. For instance, documents which have been amended, corrected, or previously recorded may also be displayed in a different format, such as an italicized font. Other categories which may facilitate a title examination are also contemplated. Additionally, a default format may be used to display records which are not associated with a particular organizational category for which an altered display is desired.

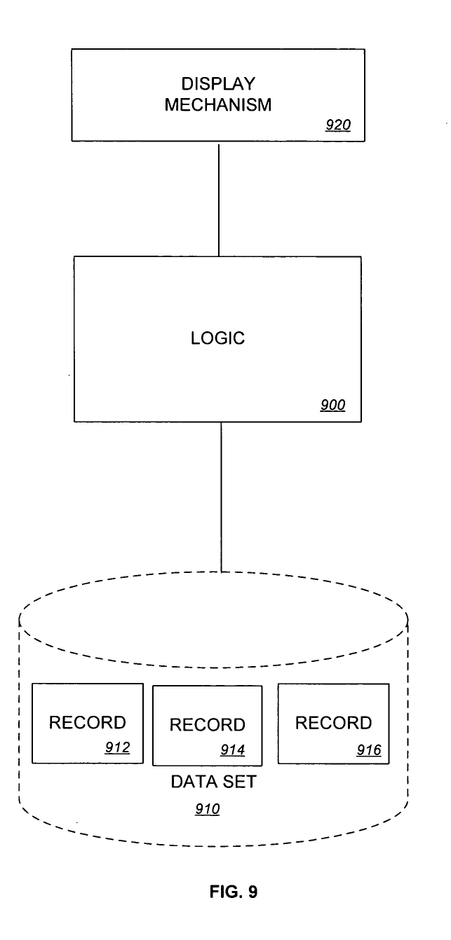

FIG. 9 illustrates an exemplary embodiment of a system that may be used to organize and display documents for a title examination retrieve records. The system includes a display mechanism 920 communicatively coupled to logic 900. By way of example, logic 100 may be program code residing on a computer readable medium. Logic 900 may also be embodied in firmware or a combination of firmware and software. Logic 900 may be used to implement the methods previously describe to organize and display documents for a title examination.

The display mechanism 920 may be any type of user interface, such as a computer monitor, that may be used to display information to a user. Display mechanism 920 is used to display records associated with recorded documents in the manner determined by logic 900. Display mechanism 920 may also be used to display one or more organizational links between the records.

In some embodiments, logic 900 may additionally be used to search a data set 910 containing one or more records 912, 914, 916 associated with recorded documents. The search may be performed as described in previously incorporated application Ser. No. (Atty. Docket No. 040143-000300US). Thus, a data set 910 may optionally be communicatively coupled to logic 900. The records retrieved by the search may be organized and displayed in any of the mechanisms previously described. In alternate embodiments, logic 900 may be communicatively coupled to separate logic (not illustrated) which searches data set 910.

Data set 900 may be any type of data set having attribute values. In one embodiment, data set 110 may be embodied in a relational database with a plurality of tables. The tables may include normalized document meta-data (e.g., recordation date, government identifier, document date, document type), normalized location data (e.g., subdivision identification, block, lot, tract), normalized name data for names referred to by documents and the role associated with the name for the document (e.g., seller, buyer, lien holder, etc.), normalized address data, normalized parcel identification data, and/or normalized document reference data linking two documents. It should be appreciated that data set 110 may include additional information related to documents recorded with government entities as described more fully in application Ser. No. ______ (Atty. docket No. 040143-000200US), previously incorporated by reference. In alternate embodiments, data set 900 may be embodied in a spreadsheet, one or more text documents, program code lists, or other format for storing data on recorded documents.

In the configuration described above, different components were described as being communicatively coupled to other components. A communicative coupling is a coupling that allows communication between the components. This coupling may be by means of a bus, cable, network, wireless mechanism, program code call (e.g., modular or procedural call) or other mechanism that allows communication between the components. Thus, it should be appreciated that logic 900, display mechanism 920, and data set 910 may reside on the same or different physical devices.

In the foregoing description, for the purposes of illustration, methods were described in a particular order. It should be appreciated that, the methods may be performed simultaneously and/or in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A computerized method for organizing and displaying documents for a title examination, the method comprising:
receiving a plurality of records, each record having a plurality of attributes associated with a document recorded with a government entity;
creating a plurality of organization links, each link defining a relationship from a document associated with one of the records to a second document associated with a second one of the records;
displaying the records; and
displaying the created links between the records.

2. The method of claim 1, wherein creating the organizational links comprises:
creating an assignment link from a first record associated with a first document to a second record associated with a second document assigned to the first document.

3. The method of claim 1, wherein creating the organizational links comprises:
creating a positive cure link from a first record associated with a lien document to a second record associated with a cure document that cures the lien.

4. The method of claim 1, wherein creating the organization links comprises:
creating a probable cure link from a first record associated with a lien document to a second record associated with a cure document, the cure document being a probable cure to the lien document.

5. The method of claim 1, wherein creating a link comprises:
creating a link from a first record associated with a first deed document to a second record associated with a second deed document.

6. The method of claim 1, wherein creating a link comprises:
creating a link from a first record associated with a first document to a second record associated with a second document, wherein the second document amends the first document.

7. The method of claim 1, wherein creating a link comprises:
creating a link from a first record associated with a first document to a second record associated with a second document, wherein the second document is a re-recordation of the first document.

8. The method of claim 1, wherein creating a link comprises:
creating a link from a first record associated with a deed document to a second record associated with a mortgage document.

9. The method of claim 1, wherein creating a link comprises:
creating a link from a first record associated with a lien document to a second record associated with a release document partially releasing the lien.

10. The method of claim 1, further comprising, before displaying the records, creating a sentinel link from one of the records to an indicator of an organizational property associated with the record.

11. The method of claim 10, wherein creating the sentinel link comprises creating a link from the record to a simulated record associated with a simulated document, the simulated document indicating the organizational property.

12. The method of claim 10, wherein the records are received from search logic using an initial one of the records as a starting point for the search and wherein creating the sentinel link comprises creating a link from the initial record to a starting search indicator.

13. The method of claim 10, wherein creating the sentinel link comprises:
determining the record is associated with a good stop document, the record being a good stop for a title search; and
creating a link from the record to a good stop indicator.

14. The method of claim 13, wherein determining the record is associated with a good stop document comprises:
determining the record is associated with a deed document;
determining the records include a record associated with a mortgage document linked to the deed.

15. The method of claim 13, wherein determining the record is associated with a good stop document comprises:
determining the record is associated with a deed document having a subdivision developer grantor.

16. The method of claim 13, wherein determining the record is associated with a good stop document comprises:
determining the record is associated with a warranty deed document having a first date;
determining the records include a second record associated with a second warranty deed document having a second date later than the first date; and
determining the records do not include a third deed record having a date between the first date and the second date.

17. The method of claim 13, wherein determining the record is associated with a good stop document comprises determining the record is associated with a government transfer deed.

18. The method of claim 10, wherein creating the sentinel link comprises:
determining the records do not include a good stop record associated with a document being a good stop for a title search;
selecting a deed record from the records; and
creating a link from the deed record to a no good stop indicator.

19. The method of claim 10, wherein creating the sentinel link comprises:
determining the record is associated with a lien document;
determining the records do not include a release record associated with a document that cures the lien; and
creating a link from the record to a non-cured indicator.

20. The method of claim 10, wherein creating the sentinel link comprises:
determining the record is associated with a document which may cloud ownership of a property; and
creating a link from the record to a title cloud indicator.

21. The method of claim 10, wherein creating the sentinel link comprises:
determining the record does not include a location attribute; and
creating a link from the record to a name indicator indicating the record is associated with a name and not a location.

22. The method of claim 1, wherein displaying the records comprises displaying the records in an ordered list ordered by a record date attribute of the records, the displayed attributes of the records further including one or more of a reception number, a document type, a document category, a grantee name, and a grantor name.

23. The method of claim 1, wherein displaying the records comprises displaying each of the records as a node in a graph, the displayed attributes of each of the records attributes including one or more of a recordation date, a reception number, and a document type.

24. The method of claim 23, wherein displaying the created links comprises displaying the created links as edges in the graph.

25. The method of claim 1, wherein displaying the records comprises displaying the records in a first level of a hierarchical display format.

26. The method of a claim 25, wherein displaying the created links comprises for each of the records displayed in the first level, displaying the records linked to the first level record at a nested level lower than the first level.

27. The method of claim 25, wherein the hierarchical display format comprises a hierarchical tree format.

28. The method of claim 1, wherein displaying the records comprises displaying the records in a color-coded format, the color indicating an organizational category of the document associated with the record.

29. The method of claim 28, wherein the organizational categories include one or more of non-cured documents, possibly cured documents, documents which may cloud title to a property, cured lien documents, cured documents releasing a non-returned lien document, and good-stop documents for a title search.

30. The method of claim 28, wherein the records are received from search logic using an initial one of the records as a starting point for the search, the method further comprising color-coding the initial record to indicate the record is the starting record.

31. A computerized method for organizing and displaying documents for a title examination, the method comprising:
receiving a plurality of records, each record having a plurality of attributes associated with a document recorded with a government entity;
creating curing links, each curing link defining a curing relationship between one of the records associated with a lien document and a second one of the records associated with a cure document that releases the lien;
creating one or more sentinel links, each sentinel link associating one of the records to an indicator of an organizational property associated with the record;
color coding the records with a color indicating a category of the record;
displaying the records using the color code, the displayed attributes of the records including a recordation date, a reception number, and a document category; and
displaying the created links between the records.

32. The method of claim 31, wherein creating a sentinel link comprises creating a link from a record to an indicator indicating one of a starting search indicator, a good stop indicator, and a non-cured indicator.

33. The method of claim 31, wherein displaying the records comprises displaying each of the records as a node in a graph and wherein displaying the created links comprises displaying the links as edges in the graph.

34. The method of claim 31, wherein displaying the records comprises displaying each record in a first hierarchical level and wherein displaying the created links comprises for each of the records displayed in the first level, displaying the records linked to the first level record at a nested level lower than the first level.

35. A system comprising:
logic, to receive a plurality of records having a plurality of attributes associated with a document recorded with a government entity, to create a plurality of organization links, each link defining a relationship from a first document associated with one of the records to a second document associated with a second one of the records; and
a display mechanism communicatively coupled to the logic, the display mechanism to display the records and the created links.

36. The system of claim 35, wherein the logic creates organizational links between records associated with documents having one or more of an assignment relationship, a curing relationship indicating the first document cures the second document, a corrective relationship indicting the first document corrects the second document, an amendment relationship indicating the first document amends the second document, and a mortgage relationship indicating the first document places a mortgage on a deed associated with the second document.

37. The system of claim 35, wherein the logic is further to create a sentinel link from one of the records to an indicator of an organizational property associated with the record.

38. The system of claim 37, wherein the logic creates the sentinel link for one of a record used as a starting point for a title search, a record associated with a good stop document for the title search, a record associated with a non-cured lien document, and a record associated with a document which may cloud ownership of a property.

39. The system of claim 35, wherein the display mechanism displays the records as nodes in a graph and displays the links as edges in the graph.

40. The system of claim 35, wherein the display mechanism displays the records in a first level of a hierarchical display format and displays the records linked to the first-level records in a nested level lower than the first level.

41. The system of claim 35, wherein the display mechanism displays the records in a color-coded format indicating an organizational category of the document associated with the record.

42. The method of claim 41, wherein the organizational categories include one or more of non-cured documents, possibly cured documents, documents which may cloud title to a property, cured lien documents, cured documents releasing a non-returned lien document, and good stop documents for a title search.
